(19) United States
(12) Patent Application Publication
(10) Pub. No.: US 2014/0317885 A1
(43) Pub. Date: Oct. 30, 2014

(54) MOUNTING APPARATUS FOR DATA STORAGE DEVICE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: ZHENG-HENG SUN, New Taipei (TW); CHENG-FEI WENG, Shenzhen (CN)

(73) Assignees: HONG FU JIN PRECISION INDUSTRY (ShenZhen) CO., LTD, Shenzhen (CN); HON HAI PRECISION INDUSTRY CO., LTD., New Taipei (TW)

(21) Appl. No.: 14/059,687

(22) Filed: Oct. 22, 2013

(30) Foreign Application Priority Data
Apr. 25, 2013 (CN) 2013101472787

(51) Int. Cl. E05D 13/00

(52) U.S. Cl. CPC E05D 13/00
USPC 16/94 R

(57) ABSTRACT

A mounting apparatus for mounting a data storage device includes an enclosure and two mounting members fixed to a bottom of the data storage device. The enclosure includes a bottom wall, a first slide rail and a second slide rail raised on the bottom wall, and two posts extending on the bottom wall. The first slide rail defines a locking slot. The mounting members each comprise a locking plate and a resilient locking portion. The locking plate defines an access portion and a locking hole communicating with the inletting portion. One of the mounting members forms a wedge portion. The data storage device is supported on the first slide rail and the second slide rail. The posts are inserted in the access portions. The data storage device is moved to make the head portions be blocked by the locking plate. The wedge portion is locked in the locking slot.

### BACKGROUND

1. Technical Field

The present disclosure relates to a mounting apparatus for a data storage device.

2. Description of Related Art

An electronic device, such as a computer, is generally equipped with a data storage device, such as a hard disk drive. Mounting the storage device to the electronic device by traditional screw type fasteners is inefficient and always requires tools, such as a screwdriver.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled, isometric view of an exemplary embodiment of a mounting apparatus and a data storage device, wherein the mounting apparatus includes an enclosure and two mounting members.

FIG. 2 is an exploded, isometric view of FIG. 1.

FIG. 3 is an enlarged view of the circled part III of FIG. 2.

FIG. 4 and FIG. 5 are enlarged views of one of the mounting members of FIG. 1, but viewed from different perspective.

FIG. 6 is an assembled, inverted view of the mounting member and the data storage device of FIG. 2.

FIG. 7 is an assembled view of the mounting member and the enclosure of FIG. 2.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

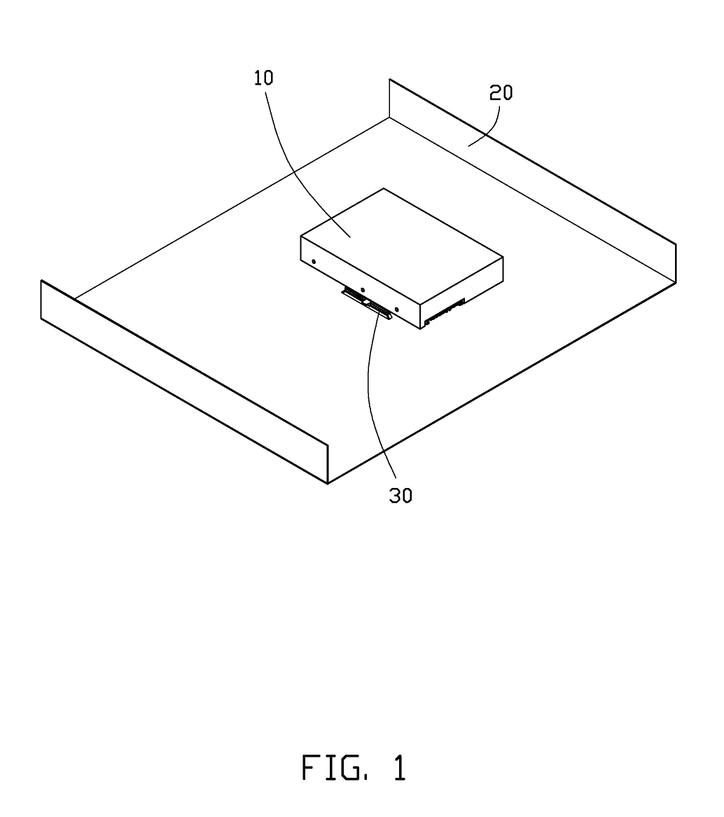

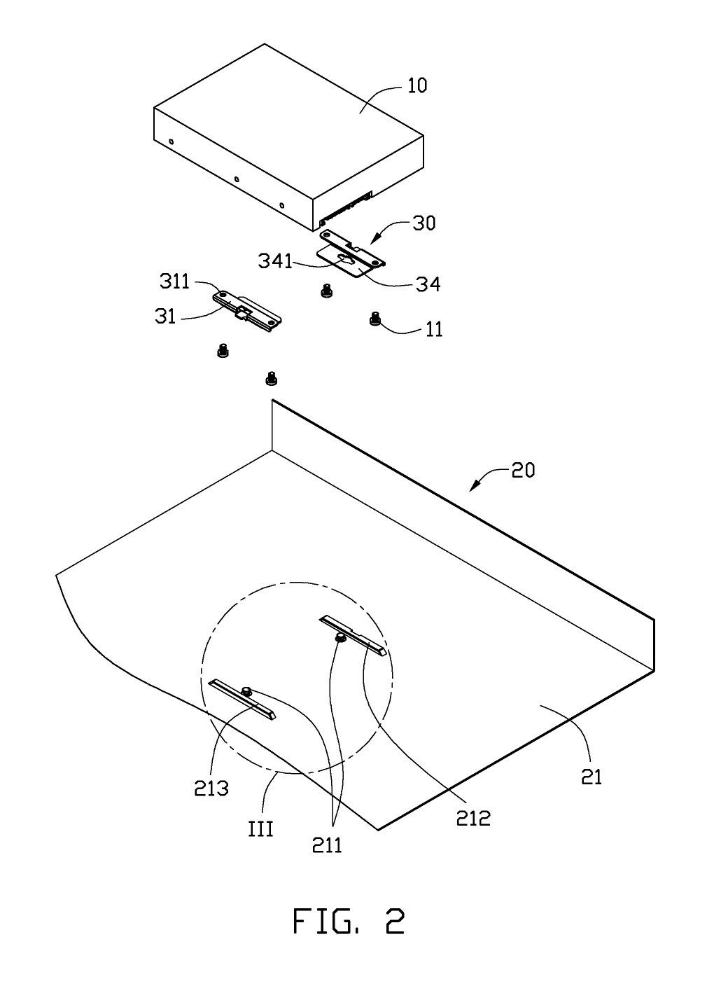

FIG. 1 and FIG. 2 show an exemplary embodiment of a mounting apparatus. The mounting apparatus is used for mounting a data storage device 10, such as a hard disk drive. The mounting apparatus includes an enclosure 20, two mounting members 30, and a plurality of screws 11.

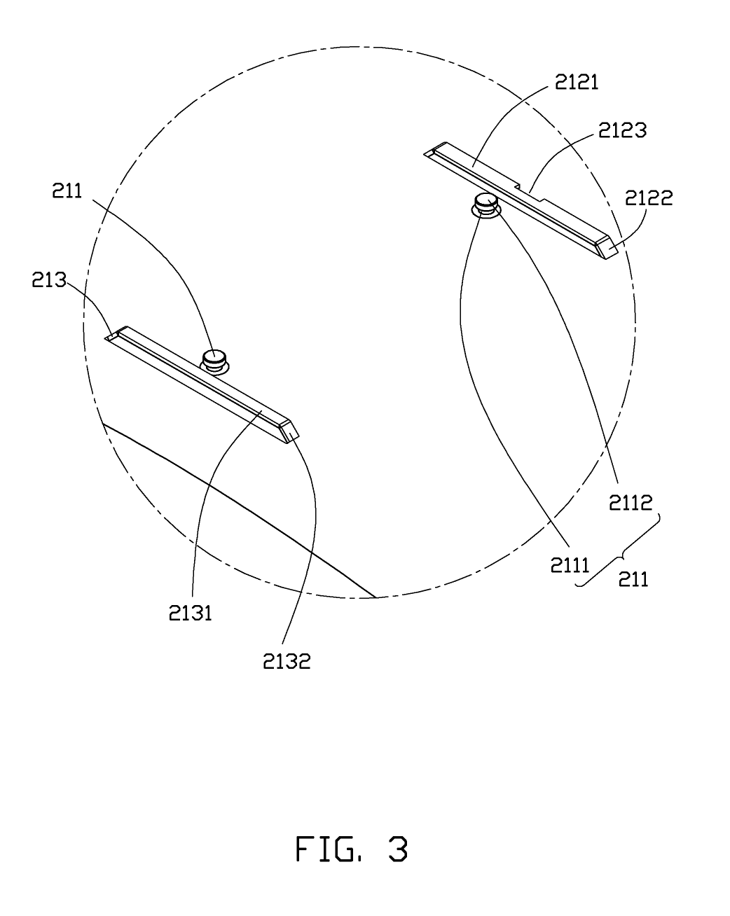

FIG. 3 shows that the enclosure 20 includes a bottom wall 21. The bottom wall 21 forms a first slide rail 212 and a second slide rail 213 parallel to the first slide rail 212. The bottom wall 21 forms two posts 211 between the first and second slide rails 212 and 213, and adjacent to the first and second slide rails 212 and 213 respectively. The first slide rail 212 is substantially bridge shaped and includes an engaging piece 2121 parallel to the bottom wall 21 and two supporting pieces 2122 slantingly connected between the bottom wall 21 and two opposite ends of the engaging piece 2121. The engaging piece 2121 defines a locking slot 2123 in a side of the engaging piece 2121 opposite to the second slide rail 213. The second slide rail 213 is substantially bridge shaped and includes an engaging piece 2131 parallel to the bottom wall 21 and two supporting pieces 2132 slantingly connected between the bottom wall 21 and two opposite ends of the engaging piece 2131. Each post 211 includes a head portion 2112 and a neck portion 2111 connected between the head portion 2112 and the bottom wall 21. A diameter of the head portion 2112 is greater than a diameter of the neck portion 2111.

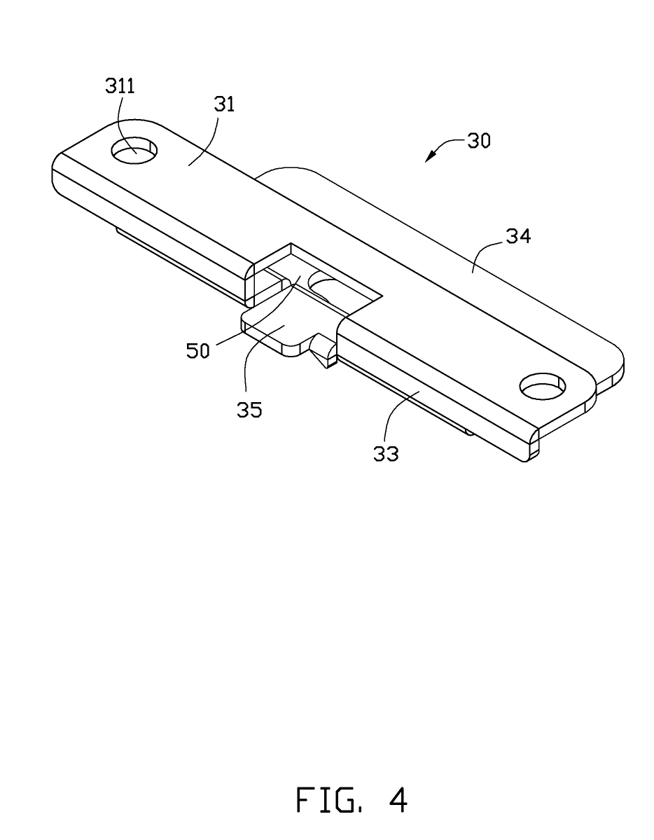

FIG. 4 shows that each mounting member 30 includes a mounting plate 31, a buffering portion 33, a locking plate 34, and a locking portion 35. The mounting plate 31 defines two screw holes 311 in two opposite ends.

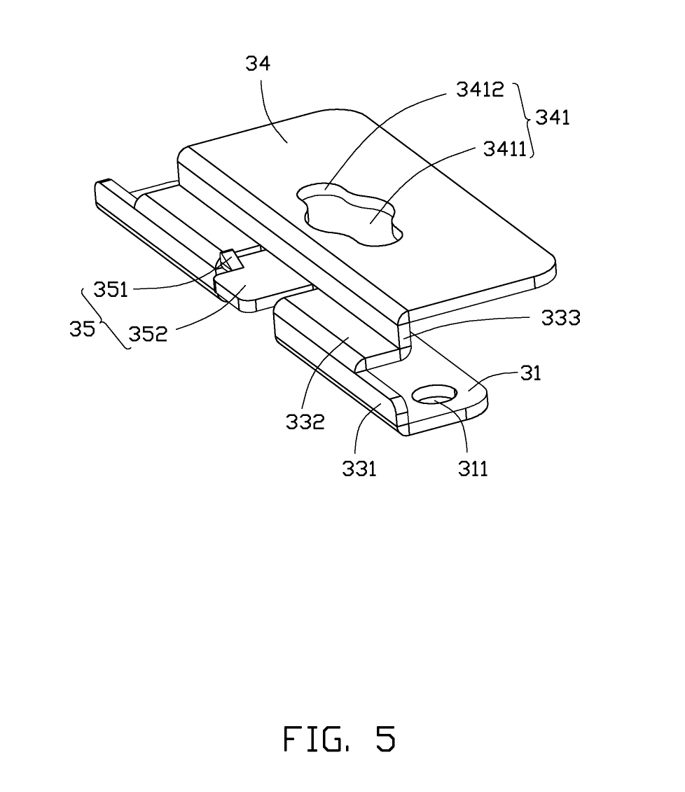

FIG. 5 shows that the buffering portion 33 is connected between sides of the mounting plate 31 and the locking plate 34. The buffering portion 33 is substantially Z-shaped, and includes a first resilient plate 331 extending up from one side of the mounting plate 31, a second resilient plate 332 extending from a top of the first resilient plate 331 and parallel to the mounting plate 31, and a third resilient plate 333 extending from one side of the second resilient plate 332 opposite to the first resilient plate 331 and connected to the locking plate 34. The locking plate 34 defines an assembling hole 341. The assembling hole 341 includes an access portion 3411 and two locking holes 3412 communicating with opposite ends of the access portion 3411. The second resilient plate 332 defines a cutout 50 extending through the first resilient plate 331. The locking portion 35 extends toward the cutout 50 from a junction of the second resilient plate 332 and the third resilient plate 333. The locking portion 35 includes an operation piece 352 parallel to the locking plate 34, and a wedge portion 351 extending toward the locking plate 34 from a side of the operation piece 352.

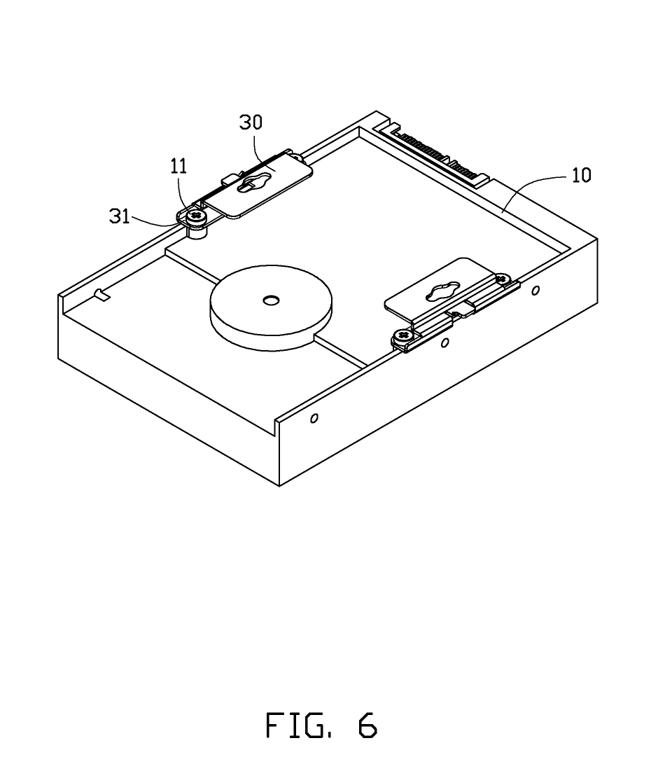

FIG. 6 shows that in assembly, the mounting members 30 are fixed to opposite sides of a bottom of the data storage device 10 via the screws 11 extending through the screwing holes 311 to screw into the bottom of the data storage device 10. The locking plate 34 is apart from the bottom of the data storage device 10.

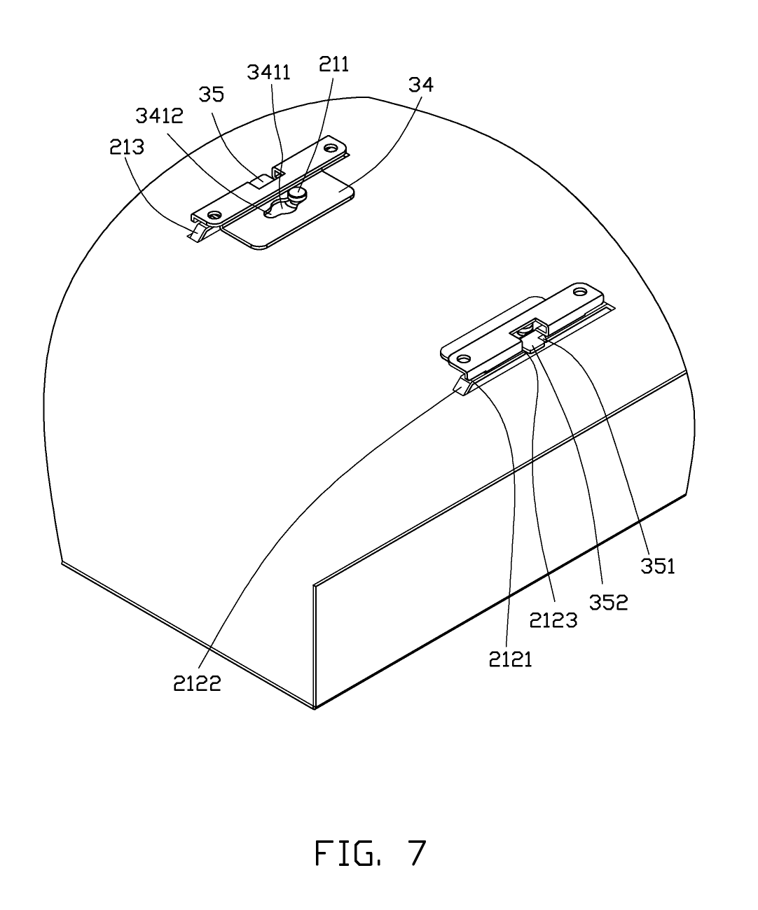

FIG. 7 shows that when mounting the data storage device 10, the data storage device 10 and the mounting members 30 are supported on the first slide rail 212 and the second slide rail 213. The posts 211 are inserted in the access portions 3411. The data storage device 10 is moved along a first direction to make the neck portions 2111 engage in the corresponding locking holes 3412. The locking plate 34 blocks the head portions 2112. The second resilient plates 332 are respectively supported on the first slide rail 212 and the second slide rail 213. The third resilient plates 333 abut against inner sides of the first slide rail 212 and the second slide rail 213 facing the posts 211. The wedge portion 351 of the mounting member 30 corresponding to the first slide rail 212 is locked in the locking slot 2123. Thus, the data storage device 10 is fixed to the enclosure 20.

In disassembly, the operation piece 352 is pulled up until the wedge portion 351 is released from the locking slot 2123. The data storage device 10 is then moved along a second direction opposite to the first direction, to remove the posts 211 from the locking hole 3412 and enter the access portion 3411. The data storage device 10 is then moved up to be disassembled from the enclosure 20.

It is to be understood, however, that even though numerous characteristics and advantages of the embodiments have been set forth in the foregoing description, together with details of the structure and function of the embodiments, the present disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A mounting apparatus for mounting a data storage device, comprising:
an enclosure comprising a bottom wall, a first slide rail and a second slide rail raised on the bottom wall, and two posts extending on the bottom wall and adjacent to the first and second slide rails respectively, wherein the first slide rail defines a locking slot, each of the posts comprises a head portion and a neck portion connected between the head portion and the bottom wall; and
two mounting members to be fixed to a bottom of the data storage device, wherein the mounting members each comprise a locking plate and a resilient locking portion, the locking plate defines an access portion and a locking hole communicating with the access portion, one of the mounting members corresponding to the first slide rail forms a wedge portion;
wherein, when mounting the data storage device, the data storage device is supported on the first slide rail and the second slide rail, the posts are inserted in the access portions, the data storage device is moved to make the neck portions engage in the corresponding locking holes, the head portions are blocked by the locking plate, the wedge portion is locked in the locking slot.

2. The mounting apparatus of claim 1, wherein each of the mounting members further comprises a mounting plate fixed to the data storage device and a buffering portion connected between the mounting and the locking plate.

3. The mounting apparatus of claim 2, wherein the mounting plate is parallel to the locking plate.

4. The mounting apparatus of claim 2, wherein the buffering portion comprises a first resilient plate extending up from one side of the mounting plate, a second resilient plate extending from a top of the first resilient plate and parallel to the mounting plate, and a third resilient plate extending from one side of the second resilient plate opposite to the first resilient plate and connected to the locking plate.

5. The mounting apparatus of claim 4, wherein the second resilient plates are respectively supported on the first slide rail and the second slide rail.

6. The mounting apparatus of claim 4, wherein the third resilient plates abut against inner sides of the first slide rail and the second slide rail facing the posts.

7. The mounting apparatus of claim 4, wherein the second resilient plate defines a cutout, the locking portion extends toward the cutout from a junction of the second resilient plate and the third resilient plate.

8. The mounting apparatus of claim 7, wherein the locking portion comprises a resilient operation piece parallel to the locking plate, and the wedge portion extends toward the locking plate from a side of the operation piece.

9. An assembly, comprising:
a data storage device;
an enclosure comprising a bottom wall, a first slide rail and a second slide rail raised on the bottom wall, and two posts extending on the bottom wall and adjacent to the first and second slide rails respectively, wherein the first slide rail defines a locking slot, each of the posts comprises a head portion and a neck portion connected between the head portion and the bottom wall; and
two mounting members fixed to a bottom of the data storage device, wherein the mounting members each comprise a locking plate and a resilient locking portion, the locking plate defines an access portion and a locking hole communicating with the access portion, one of the mounting members corresponding to the first slide rail forms a wedge portion;
wherein the data storage device is supported on the first slide rail and the second slide rail, the posts are inserted in the access portions, the data storage device is moved to make the neck portions engage in the corresponding locking holes, the head portions are blocked by the locking plate, the wedge portion is locked in the locking slot.

10. The assembly of claim 9, wherein each of the mounting members comprises a mounting plate fixed to the data storage device and a buffering portion connected between the mounting and the locking plate.

11. The assembly of claim 10, wherein the mounting plate is parallel to the locking plate.

12. The assembly of claim 10, wherein the buffering portion comprises a first resilient plate extending up from one side of the mounting plate, a second resilient plate extending from a top of the first resilient plate and parallel to the mounting plate, and a third resilient plate extending from one side of the second resilient plate opposite to the first resilient plate and connected to the locking plate.

13. The assembly of claim 12, wherein the second resilient plates are respectively supported on the first slide rail and the second slide rail.

14. The assembly of claim 12, wherein the third resilient plates abut against inner sides of the first slide rail and the second slide rail facing the posts.

15. The assembly of claim 12, wherein the second resilient plate defines a cutout, the locking portion extends toward the cutout from a junction of the second resilient plate and the third resilient plate.

16. The assembly of claim 15, wherein the locking portion comprises a resilient operation piece parallel to the locking plate, and the wedge portion extends toward the locking plate from a side of the operation piece.
